(19) United States
(12) Patent Application Publication
(10) Pub. No.: US 2011/0165551 A1
(43) Pub. Date: Jul. 7, 2011

(54) DEVICE AND SYSTEM FOR ASSISTING IN USING EQUIPMENT

(76) Inventors: Wataru Yamazaki, Tokyo (JP); Fumitaka Sato, Tokyo (JP); Atsushi Kono, Tokyo (JP); Hirofumi Fukumoto, Tokyo (JP)

(21) Appl. No.: 13/061,869

(22) PCT Filed: Sep. 8, 2009
(86) PCT No.: PCT/JP2009/004436

§ 371 Date: Mar. 2, 2011

(30) Foreign Application Priority Data
Oct. 20, 2008 (JP) 2008-270032

(51) Int. Cl. G09B 25/00

(52) U.S. Cl. 434/365

(57) ABSTRACT

On the basis of both screen transition data showing a correspondence between data showing whether a screen transition among operation screens is enabled or disabled and screen identifiers each identifying one of the operation screens, and associated data showing a correspondence between a manual item identifier and a screen identifier identifying an operation screen for enabling an operation based on an operation item specified by the manual item identifier to be performed, an information-to-be-presented deriving unit derives an operation screen corresponding to a manual item identifier acquired by a browsing detecting unit 3, and then displays this operation screen on an equipment display unit 10.

### FIELD OF THE INVENTION

The present invention relates to a device for assisting in using equipment that assists a user in using vehicle-mounted information equipment or the like, and a system for assisting in using equipment using this device for assisting in using equipment.

### BACKGROUND OF THE INVENTION

In recent years, vehicle-mounted information equipment, such as a car navigation system, has become widespread, and has various functions mounted therein. Therefore, various operation methods for using these functions are also provided, and impose a large load on users.

As a conventional technology proposed in order to solve this problem, there has been provided a help information control method disclosed by patent reference 1, for example. According to this method, by holding help information in equipment and arbitrarily storing the running state of an application program that implements the functions of the equipment, help information according to this running state is searched for and presented to the user. Thus, the help information which reflects the finer state of the application program can be presented to the user.

Furthermore, according to a program correction assisting method described in patent reference 2, when developing a software program, a corresponding section of a manual to be referred to for error correction is searched for and presented to the user after an error message is displayed in conjunction with the execution of a compiler. As a result, the user can use the manual with more detailed comprehensibility.

### RELATED ART DOCUMENT

### Patent Reference

Patent reference 1: Japanese patent No. 2776907 gazette
Patent reference 2: JP, 2000-242481, A

### SUMMARY OF THE INVENTION

According to the method described in patent reference 1, help information can be presented to the user according to the user's operation on the equipment while the help information which is relevant to the execution situation of the application program does not specify the actual user's operation on the equipment directly and therefore the operation results cannot be acquired promptly. Furthermore, according to patent reference 1, a case in which the user reads the operation manual of the equipment and then operates the equipment is not taken into consideration, the actual user's operation on the equipment cannot be brought into correspondence with the corresponding section of the manual.

For example, in a case in which the user uses equipment, such as vehicle-mounted information equipment, in which a large display screen and an input unit for enabling complicated input settings cannot be disposed, what the user desires is typically to be able to certainly perform an equipment operation, which is specified with the corresponding section of the operation manual, on the equipment rather than to specify the operation using the help information. Furthermore, there is a case in which the user using such vehicle-mounted information equipment cannot take time to perform an operation and cannot utilize the help information itself.

In contrast, according to the method disclosed in patent reference 2, while the user is enabled to know the corresponding section of the manual, a desired operation on the equipment (an operation screen or the like) is not specified from the operation manual, and the operation results are not acquired promptly. Furthermore, patent reference 2 only discloses how to present the corresponding section of the manual to be referred to for error correction to the user, but does not describe any information about a method of assisting user in operating the equipment.

The present invention is made in order to solve the above-mentioned problems, and it is therefore an object of the present invention to provide a device for assisting in using equipment that can search for a desired operation from an operation manual to enable the user to perform the operation, and that can carry out learning and an update of operation information, and a system for assisting in using equipment using this device for assisting in using equipment.

In accordance with the present invention, there is provided a device for assisting in using equipment that assists in operating target equipment according to an operation manual, the above-mentioned device including: an identifier acquiring unit for acquiring an operation item identifier identifying an operation item described in the above-mentioned operation manual; a first storing unit for storing screen transition data showing a correspondence between data showing whether a screen transition among operation screens is enabled or disabled, and screen identifiers each identifying one of the above-mentioned operation screens; a second storing unit for storing associated data showing a correspondence between the above-mentioned operation item identifier and a screen identifier identifying an operation screen for enabling an operation based on the operation item specified by the above-mentioned operation item identifier to be performed; and an information-to-be-presented deriving unit for deriving an operation screen corresponding to the operation item identifier acquired by the above-mentioned identifier acquiring unit on a basis of the screen transition data stored in the above-mentioned first storing unit and the associated data stored in the above-mentioned second storing unit to display the above-mentioned operation screen on the above-mentioned target equipment.

The device for assisting in using equipment in accordance with the present invention includes the identifier acquiring unit for acquiring an operation item identifier identifying an operation item described in the operation manual, and derives an operation screen corresponding to an operation item identifier acquired by the identifier acquiring unit on the basis of the screen transition data showing a correspondence between the data showing whether a screen transition among operation screens is enabled or disabled, and screen identifiers each identifying one of the operation screens and the associated data showing a correspondence between the operation item identifier and a screen identifier identifying an operation screen for enabling an operation based on the operation item specified by the operation item identifier to be performed, to display the operation screen on the target equipment. By thus providing an identifier corresponding to a desired piece of operation information in the operation manual, the device for assisting in using equipment automatically searches for and displays an operation screen which enables the user to perform the above-mentioned operation. Therefore, the present invention provides an advantage of enabling the user to perform the desired operation on the target equipment certainly through a simple operation, and being able to carry out learning and an update of the operation information.

### BRIEF DESCRIPTION OF THE FIGURES

FIG. 1 is a block diagram showing the structure of a device for assisting in using equipment in accordance with Embodiment 1 of the present invention;

FIG. 2 is a view for explaining a screen transition using screen transition data which the device for assisting in using equipment in accordance with Embodiment 1 makes;

FIG. 3 is a flow chart showing a flow of assistance in using equipment based on a manual which is provided by vehicle-mounted information equipment shown in FIG. 1;

FIG. 4 is a view for explaining a process of inputting a manual item identifier;

FIG. 5 is a block diagram showing the structure of a system for assisting in using equipment in accordance with Embodiment 2 of the present invention;

FIG. 6 is a flow chart showing a flow of the operation carried out by the system for assisting in using equipment shown in FIG. 5;

FIG. 7 is a view for explaining a process of rewriting data corresponding to a new version;

FIG. 8 is a view schematically showing the structure of a system for assisting in using equipment in accordance with Embodiment 3 of the present invention; and

FIG. 9 is a timing chart showing an equipment operation carried out by the system for assisting in using equipment shown in FIG. 8.

### EMBODIMENTS OF THE INVENTION

Hereafter, in order to explain this invention in greater detail, the preferred embodiments of the present invention will be described with reference to the accompanying drawings.

### Embodiment 1

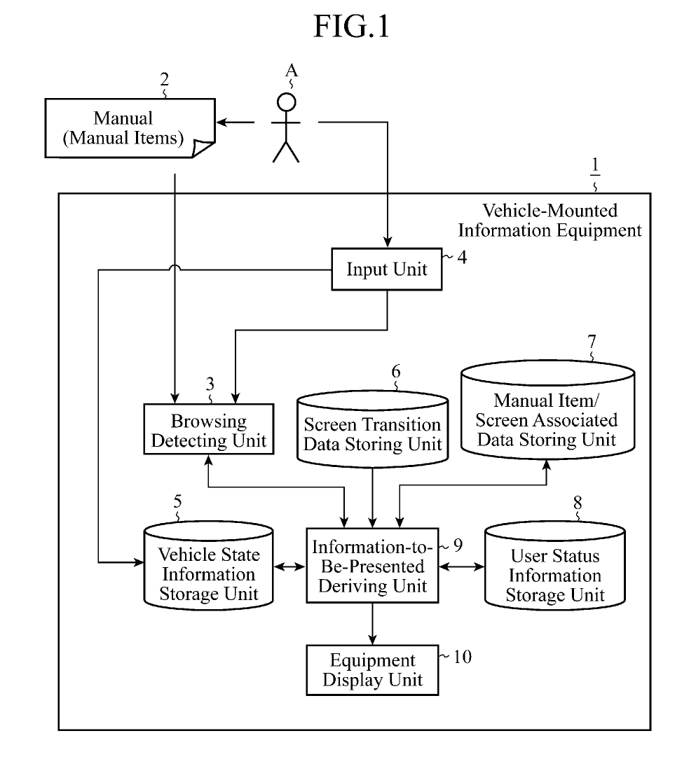

FIG. 1 is a block diagram showing the structure of a device for assisting in using equipment in accordance with Embodiment 1 of the present invention, and shows a case in which the device for assisting in using equipment in accordance with the present invention is incorporated into vehicle-mounted information equipment (a navigation device). Target equipment which a user uses by receiving assistance provided by the device for assisting in using equipment in accordance with Embodiment 1 can be disposed separately from the device. In FIG. 1, the user A operates the vehicle-mounted information equipment (the target equipment and the device for assisting in using equipment) 1 according to a manual (an operation manual) 2 in which an equipment using method is described.

The manual 2 describes the using method of using the vehicle-mounted information equipment 1 which is the operation target, and can be a paper or electronic medium. Furthermore, in the manual 2, manual item identifiers, each of which can be uniquely identified, are respectively assigned to items (referred to as manual items from here on) in each of which an operating procedure for (or an operating guide required for) using a corresponding one of functions mounted in the vehicle-mounted information equipment 1 is described.

The manual item identifiers (operation item identifiers) are held in the manual 2 in a state in which each of them can be detected by a browsing detecting unit 3 which will be mentioned below. As concrete examples of the manual item identifiers, the page numbers of the manual 2, the page images of the manual 2, bar codes, QR codes (registered trademark; this information will be omitted hereafter), the paragraph numbers of an explanatory document of the manual 2, the numbers of characters counted from the first character of the manual 2 can be provided.

The browsing detecting unit (an identifier acquiring unit) 3 is a component that detects a manual item which the user is browsing according to the manual item identifier of the manual item. For example, the browsing detecting unit can be implemented via hardware, such as a photosensor for detecting a bar code, or a liquid crystal display having a built-in photosensor. The browsing detecting unit 3 can be constructed in such a way as to automatically detect the manual item which the user is browsing according to the manual item identifier of the manual item.

Furthermore, the browsing detecting unit 3 can be constructed in such a way as to have an function of serving as an interface between an input unit (the identifier acquiring unit) 4 and an information-to-be-presented deriving unit 9, and to output the manual item identifiers (the page numbers or the like) which have been manually input to the vehicle-mounted information equipment by using the input unit 4 to the information-to-be-presented deriving unit 9 via the browsing detecting unit 3. The input unit 4 is an input means which is normally mounted in the vehicle-mounted information equipment 1, e.g., a key panel, a touch panel, a jog dial, a sound-collecting microphone, and so on.

In addition, the browsing detecting unit 3 can be constructed in such away as to detect the user's line of sight or an image from a video image or image captured with a camera so as to detect a manual item identifier and then presume the manual item which the user is browsing according to the results of the detection. For example, the browsing detecting unit allows the user to show a page number using a gesture, and analyzes an image which the browsing detecting unit has generated by capturing this gesture with a camera so as to specify the page number to presume the manual item which the user is browsing.

A vehicle state information storage unit (a third storing unit) 5 stores vehicle state information (moving object state information) including a vehicle speed and a vehicle position acquired by a positioning means using sensors mounted in the vehicle, GPS, etc., a destination which is set up by the vehicle-mounted information equipment 1, as the navigation device, after a guide route is determined, and a distance from the vehicle position to the destination. Furthermore, the vehicle state information storage unit 5 is constructed in a storage area of a memory mounted in, for example, the vehicle-mounted information equipment 1, and the information-to-be-presented deriving unit 9 can read the memory contents from the vehicle state information storage unit as needed.

Information about the vehicle inputted using the input unit 4, as well as the above-mentioned information acquired from the vehicle, is included in the vehicle state information. Furthermore, the information showing the vehicle state includes at least a running flag (data showing whether the vehicle is running or at rest), and a screen identifier identifying a display screen currently being displayed on a display unit 10 of the equipment. Information about the image itself identified by the screen identifier is constructed by a CPU executing a program module of software which is executed through the user's operation based on the manual 2.

A screen transition data storing unit (a first storing unit) 6 stores screen transition data which consist of a combination of screen identifiers each of which uniquely identifies corresponding screen information which can be displayed on the display screen of the equipment display unit 10, and pieces of information each of which shows whether a screen transition between screens identified by screen identifiers can be made. The screen transition data storing unit 6 can also be constructed in a storage area of a memory mounted in, for example, the vehicle-mounted information equipment 1, and the information-to-be-presented deriving unit 9 can read the memory contents from the screen transition data storing unit as needed.

A manual item/screen associated data storing unit (a second storing unit) 7 stores manual item/screen associated data which are a combination of the manual item identifiers and the screen identifiers of the screens each of which is displayed on the display screen of the equipment display unit 10 through the user's operation based on the manual item identified by the corresponding manual item identifier. The manual item/screen associated data storing unit 7 can also be constructed in a storage area of a memory mounted in, for example, the vehicle-mounted information equipment 1, and the information-to-be-presented deriving unit 9 can read the memory contents from the manual item/screen associated data storing unit as needed.

A user status information storage unit (a fourth storing unit) 8 stores the manual item which the user is browsing (the manual item identifier detected by the browsing detecting unit 3) and information showing the user's status (a driver flag showing, with a digital value, whether the user is driving the vehicle, or sitting in the front seat or a back seat) as user status information (information about the operator). The user status information storage unit 8 can also be constructed in a storage area of a memory mounted in, for example, the vehicle-mounted information equipment 1, and the information-to-be-presented deriving unit 9 can read the memory contents from the user status information storage unit as needed.

Furthermore, in addition to storing the user's individual data, the user status information storage unit 8 can store the user status information for each of users including the user, and the vehicle-mounted information equipment can switch among the pieces of user status information as needed to use one of them, or can perform statistical analysis on the pieces of user status information about the plurality of users to use the statistical analysis results.

The information-to-be-presented deriving unit 9 receives the manual item identifier detected by the browsing detecting unit 3 and the vehicle state information set up by using the input unit 4 to specify the user status information according to the manual item identifier and the vehicle state information, and also derives information to be presented to the user according to this user status information, the screen transition data, and the manual item/screen associated data.

The equipment display unit 10 is mounted in the vehicle-mounted information equipment 1. For example, the equipment display unit can be constructed of a liquid crystal display. As an alternative, the equipment display unit can be constructed of a touch panel which can be used also as the input unit 4.

The processing functions of the above-mentioned components 3 to 10 can be implemented as a concrete means in which hardware and software work in cooperation with each other in a computer by making the computer read a program for assisting in using equipment according to the purposes of the present invention and making the CPU of the computer execute the program to control the operation of the computer.

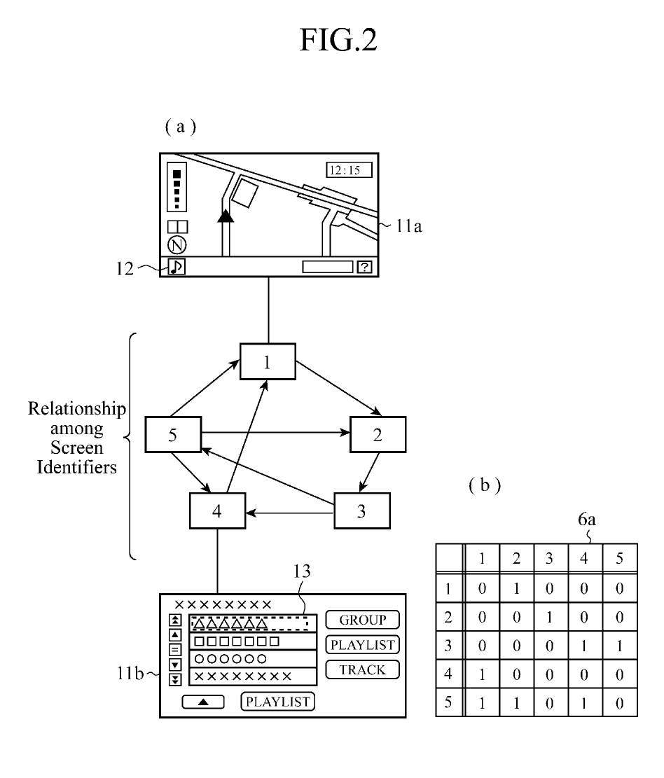

FIG. 2 is a view for explaining a screen transition according to the screen transition data in accordance with Embodiment 1, FIG. 2(a) shows a relationship between the display screens and the screen identifiers, and FIG. 2(b) shows an example of the screen transition data. As shown in FIG. 2, the screen transition data shows whether a transition between any two of the screens can be made. For example, the screen transition data can be expressed as matrix data 6a as shown in FIG. 2(b). In the matrix data 6a, whether or not a transition from one screen to another screen can be made is expressed by the digital value of a corresponding matrix element. For example, when a component (1, 2) showing whether or not a transition from the screen identified by the screen identifier 1 to the screen identified by the screen identifier 2 has a digital value of 1, the component shows that a transition from the screen identified by the screen identifier 1 to the screen identified by the screen identifier 2 can be made, whereas when the component (1, 2) has a digital value of 0, the component shows that no transition from the screen identified by the screen identifier 1 to the screen identified by the screen identifier 2 can be made.

Concretely explaining a screen transition with reference to the example of FIG. 2(a), when causing the vehicle-mounted information equipment to make a transition from a screen 11a for navigation having a screen identifier of 1 to a music playback screen 11b having a screen identifier of 4, the user pushes down a button 12 shown in the screen 11a to make the vehicle-mounted information equipment display a screen (having a screen identifier of 2) (not shown in the figure), further pushes down a button 12 to make the vehicle-mounted information equipment display a musical piece selection screen (having a screen identifier of 3) (not shown in the figure), and selects a musical piece in the musical piece selection screen, so that the vehicle-mounted information equipment makes a transition to the music playback screen 11b for displaying the musical piece currently being played back in a musical piece column 13.

The method of forming the screen transition data is not limited to the matrix representation. As an alternative, a method of recording only a combination of screens between which a transition can be made, a method of forming the matrix into a transposed matrix to speed up the screen transition, or the like can be provided. Because these methods are equivalent to the matrix representation from the viewpoint of representation of the screen transition data, the explanation of the details of those variations will be omitted hereafter.

Furthermore, in order to describe information showing whether a screen transition occurs at the time of occurrence of an event, each matrix component can be replaced by data according to the types of events, so that the device can support the occurrence of various events. More specifically, by using a bit pattern according to the event types, each matrix component data which enables the vehicle-mounted information equipment to determine whether or not a screen transition according to the occurrence of a certain event can be made is constructed.

For example, a case in which one of four events (a, b, c, d) can occur will be considered. Assuming that the vehicle-mounted information equipment makes a screen transition from a screen 1 (having a screen identifier of 1) to a screen 2 (having a screen identifier of 2) only in the case of the occurrence of the event a or d, a bit pattern (1, 0, 0, 1) showing the presence or absence of the occurrence of each of the events with a digital value is registered instead of the component (1, 2) shown in FIG. 2(b).

Next, the details of the manual item/screen associated data will be explained.

A correspondence between a manual item and a screen is expressed by a combination of a corresponding manual item identifier and a corresponding screen identifier. For example, when an operation screen for enabling the user to perform an operation based on a manual item having a manual item identifier of 1 has a screen identifier of A, the manual item/screen associated data is expressed as a tuple <1, A>.

Each manual item can have either of the following three states.

(1) State in which there is no corresponding screen (no corresponding screen identifier).

(2) State in which one corresponding screen (one corresponding screen identifier) is determined.

(3) State in which N (N>1) corresponding screens (N corresponding screen identifiers) are determined.

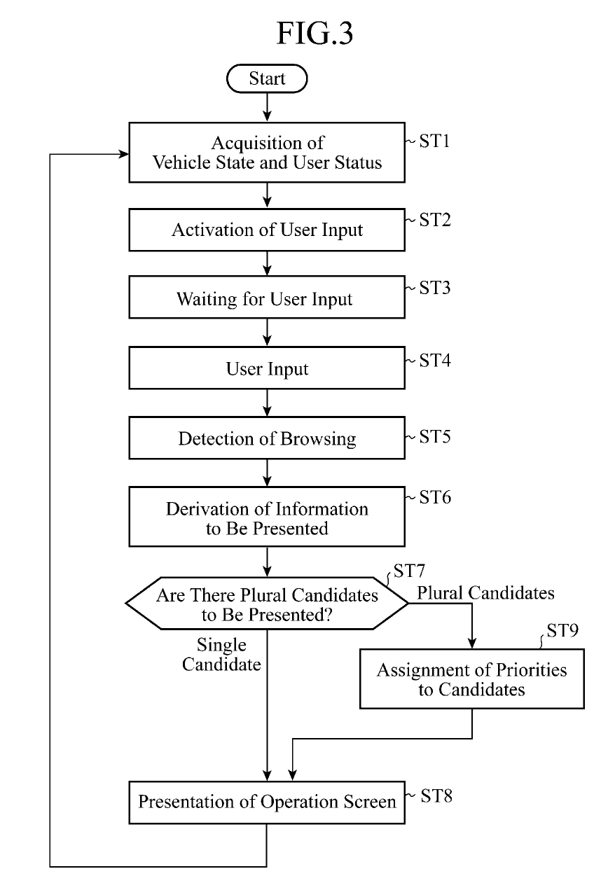

In the above-mentioned case of (2), the screen corresponding to the screen identifier is searched for and is then displayed on the equipment display unit 10. The cases of (1) and (3) will be mentioned below with reference to FIG. 3.

Next, the operation of the vehicle-mounted information equipment will be explained.

FIG. 3 is a flow chart showing a flow of an operation of assisting a user in operating the vehicle-mounted information equipment 1 shown in FIG. 1 according to its manual, and the details of the operation will be explained with reference to this flow chart.

First, the information-to-be-presented deriving unit 9 acquires at least the information showing “whether or not the vehicle is running” (the running flag; the vehicle state information) and the information showing “whether or not the user is the driver” (the driver flag; the user status information) from the information stored in the vehicle state information storage unit 5 and the information stored in the user status information storage unit 8 (step ST1).

The information-to-be-presented deriving unit 9 activates the input means which the user A is enabled to use to perform an input operation, among the input means which construct the input unit 4, according to the information acquired in step ST1 (step ST2). In this case, information showing which input means should be activated can be expressed as a tuple <r, d, i> (r: the running flag, d: the driver flag, i: the available input means) which is comprised of the value of the running flag, the value of the driver flag, and the identifier identifying the available input means. For example, when the driver is the user while the vehicle is running, any input means which urges the user A to check an on-screen image is inactivated. By thus discriminating between an input means, such as a voice input means, which the user can use while the vehicle is running, and an input means, such as a character input means, which is not suitable for use while the vehicle is running, only a transition to an operation screen which the user can operate while the vehicle is running can be displayed on the equipment display unit 10, and the user can use available functions selectively or on a priority basis even when the vehicle is running.

That tuple data can be constructed by using either of a method of statically describing the tuple data in a program for implementing the information-to-be-presented deriving unit 9, or a method of reading the tuple data from an external file, a network, or the like to dynamically determine the tuple data. After activating a user input means, the information-to-be-presented deriving unit 9 makes a transition to an input waiting state in which it waits for an input from the user A (step ST3).

In this case, when the user A makes an information input to the vehicle-mounted information equipment 1 in order to operate the vehicle-mounted information equipment 1 according to the manual 2 (step ST4), the browsing detecting unit 3 detects the manual item which the user A is browsing, and then informs the manual item to the information-to-be-presented deriving unit 9 (step ST5). The input operation performed by the user A at this time is a process of setting the manual item identifier of the manual 2 to the vehicle-mounted information equipment 1. For example, there is a case in which the user inputs a page number or an image number of the manual 2 by operating the input unit 4 manually or by voice.

There can be another case in which the browsing detecting unit 3 detects a page number of the manual 2 or recognizes a bar code by using an image captured by the camera, or detects the browsing position where the user is browsing the manual 2 by detecting the user's line of sight. As an alternative, the browsing detecting unit 3 can be constructed in such a way as to have a communications function of receiving a manual item identifier which is transmitted through the user's pushdown of a transmission button of an external terminal for transmitting the manual item identifier embedded in electronic data displayed on external terminal.

The information-to-be-presented deriving unit 9 derives one or more screen identifiers each identifying a screen which is a candidate for the information to be presented according to both the manual item/screen associated data read from the storing unit 7 and the manual item identifier detected by the browsing detecting unit 3 (step ST6). At this time, the information-to-be-presented deriving unit 9 determines whether there are two or more screen identifiers each identifying a screen which is a candidate for the information to be presented (step ST7). In this case, when there is a single screen candidate corresponding to the manual item identifier, that is, when there is a single candidate for the information to be presented, the information-to-be-presented deriving unit 9 displays the screen of the single candidate on the equipment display unit 10 as the operation screen when determining that a screen transition can be made according to the screen transition data which the information-to-be-presented deriving unit has searched for through the storing unit 6 and read on the basis of both the screen identifier of the current screen and the screen identifier of the screen of the single candidate (step ST8).

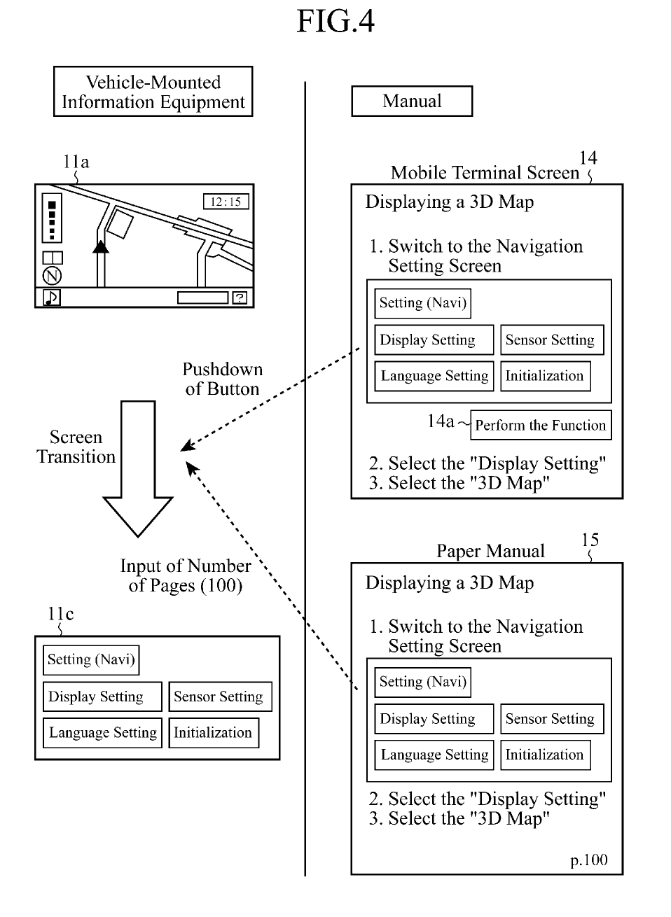

FIG. 4 is a view for explaining the input process of inputting a manual item identifier. In FIG. 4, an example in which the manual 2 is an electronic manual displayed on the display screen of a mobile terminal, and an example in which the manual 2 is a paper medium 15 are shown. Both the manuals provide an identical operation screen via which the user desires to perform an operation.

When the user pushes down a button 14a of “Execution of this function” in the display screen 14 of the mobile terminal on which the electronic manual is displayed while the vehicle-mounted information equipment 1 is displaying the map screen 11a, a GUI (Graphical User Interface) mounted in the mobile terminal recognizes the pushdown of the button 14a of “Perform the function”, and then informs the pushdown to the browsing detecting unit 3 (or the input unit 4) of the vehicle-mounted information equipment 1 by using the communications function thereof.

In the browsing detecting unit 3, the manual item identifier which corresponds to the button 14a of “Perform the function” in the electronic manual of the mobile terminal is registered beforehand. According to which button 14a of “Perform the function” has been pushed down, the browsing detecting unit 3 identifies the manual item identifier corresponding to this button, and informs the manual item identifier to the information-to-be-presented deriving unit 9.

The information-to-be-presented deriving unit 9 derives one or more screen identifiers each showing a screen which is a candidate for the information to be presented according to both the manual item/screen associated data read from the storing unit 7 and the manual item identifier detected by the browsing detecting unit 3. In FIG. 4, it is assumed that the screen identifier of a screen 11c is derived as a single candidate. After that, the information-to-be-presented deriving unit 9 searches through the storing unit 6 by using the screen identifier of the current screen 11a and the screen identifier of the screen 11c to read the corresponding screen transition data, and, when determining that a screen transition from the current screen to the screen 11c can be made according to this screen transition data, displays the screen 11c on the equipment display unit 10 as the operation screen.

In contrast with this, in the case of using the manual 15 which is a paper medium, the user A inputs, as a manual item identifier, a page number (in the illustrated example, a page number of 100) to the vehicle-mounted information equipment 1 by using the input unit 4. The manual item identifier corresponding to the page number in the manual 15 which is a paper medium is registered beforehand into the browsing detecting unit 3, and the browsing detecting unit 3 identifies the manual item identifier which matches the inputted manual item identifier and then informs the manual item identifier to the information-to-be-presented deriving unit 9. Subsequent processes are the same as those mentioned above.

Returning to the explanation with reference to FIG. 3, the information-to-be-presented deriving unit 9, in step ST7, can filter any screen transition which is not suitable while the vehicle is running according to the values of the running flag and the driver flag acquired in step ST1. As examples of a screen display which is not suitable while the vehicle is running, there are a display of a 50 phonetic sound key input, a television program listing display, etc. which require the user to fix the user's eyes on the screen.

In this case, the filtering can be implemented by registering a list of screens to be filtered under each of certain conditions (e.g., in the user status specified by the values of the running flag and the driver flag) into the information-to-be-presented deriving unit 9 in advance, and searching for a list corresponding to a certain condition. For example, in a case in which the status in which the vehicle is running is expressed as running and the screen identifiers of the screens which are not suitable while the vehicle is running are 100, 200, and 300, such data as <running:100,200,300> can be registered into the information-to-be-presented deriving unit.

When there are two or more candidates to be presented in step ST7, the information-to-be-presented deriving unit 9 adds a screen display priority to each of the candidates according to the user status specified by the user status information, produces a selection screen which enables the user to select a candidate which the user desires from the plurality of candidates to be presented according to the priority, and displays the selection screen on the equipment display unit 10 (step ST10).

There can be considered a method of displaying, as an example of the selection screen, a screen showing pieces of information which identify the screen candidates respectively in order of priority (such as screen identifiers or the screen candidates' reduced screens (a thumbnail)). In this case, the information-to-be-presented deriving unit 9 can store tuple data <id, val> (in this case, id is each screen identifier and val is the priority of each screen identifier), which is a combination of the screen identifier and the priority, in the user status information storage unit 8 as user status information, and read these tuple data as needed to produce the selection screen.

After acquiring a sequence of screen identifiers <id_1, id_2, . . . , id_n> of n candidates to be presented by reading the user status information as mentioned above as needed and then using the user status information, the information-to-be-presented deriving unit acquires a group <val_1, . . . , val_n> of the priorities of the screen identifiers id_1 to id_n. As a result, the screen identifier (e.g., id_max) having the highest priority (e.g., expressed as val_max) can be displayed. Furthermore, the priorities can also be used to simultaneously display the plurality of candidates as a list and determine the order in which they are listed at the time when allowing the user to select one of them.

The priorities can be set up according to the frequency with which each of the screens appears in the manual 2, or can be set up in the order of the sizes of the screens described in the manual 2. As an alternative, the priorities can be set up according to the frequency with which each of the screens has been used in the past. For example, in the case in which the user uses the manual 15 which is a paper medium, when a plurality of operation screens are described in one page, a higher priority is assigned to an operation screen having a higher frequency with which it appears in this manual, a higher priority is assigned to a screen having a larger size described in the manual, or a higher priority is assigned to a screen having a higher frequency with which it has been used. By carrying out such a priority assignment, the priorities can be reflected through the selection of a screen to be displayed on the instrument display unit 10, and the display of the list.

There is a case in which no one screen corresponding to the manual item identifier detected by the browsing detecting unit 3 cannot be derived, depending upon the structure of the manual item/screen associated data. General equipment including the device for assisting in using equipment, such as the vehicle-mounted information equipment 1, is constructed in such a way as to, at that time, make a screen transition to a top screen (an initial screen) which is usually displayed when the equipment 1 starts. As a result, the equipment can be prevented from entering a state in which it does not produce any screen display because of no candidate.

Furthermore, the vehicle-mounted information equipment can be constructed in such a way as to hold the user's history as user status information to enable the information-to-be-presented deriving unit 9 to dynamically determine the priority of each of the plurality of candidates derived thereby. In this case, the vehicle-mounted information equipment can display the information to be presented which has been selected on a priority basis. In addition, the vehicle-mounted information equipment can display the user's history on a priority basis at the time when making a search for the manual item. This display of the user's history can be implemented by using a method of implementing the user's history or a mechanism of assigning priorities as explained above. More specifically, the tuple data <id, val> can be constructed in such a way as to vary according to the using state of the tuple data.

Furthermore, because the user status differs for each user, the vehicle-mounted information equipment can be constructed in such a way as to switch among a plurality of users to enable one of the users to use the vehicle-mounted information equipment by using an existing personal authentication technology, and providing the storage units 5 and 8 and the storing units 6 and 7 for each of the users, or dividing each storage area into a plurality of portions.

In addition, the user's history data can be managed on a server with which the vehicle-mounted information equipment can communicate. In this case, the vehicle-mounted information equipment can derive a tendency in the use of the manual by using a method, such as collaborative filtering, and use the tendency for the priority assignment.

As mentioned above, in accordance with this Embodiment 1, the information-to-be-presented deriving unit derives an operation screen corresponding to a manual item identifier acquired by the browsing detecting unit 3 on the basis of both the screen transition data showing a correspondence between the data showing whether a screen transition among operation screens is enabled or disabled, and the screen identifiers each identifying one of the operation screens and the associated data showing a correspondence between the manual item identifier and a screen identifier identifying an operation screen for enabling an operation based on the operation item specified by the above-mentioned manual item identifier to be performed, and then displays the above-mentioned operation screen on the equipment display unit 10. By thus providing a manual item identifier corresponding to a desired piece of operation information in the manual 2, the vehicle-mounted information equipment automatically searches for and displays an operation screen which enables the user to perform the above-mentioned operation. The vehicle-mounted information equipment enables the user to perform the desired operation thereon certainly through a simple operation, and can carry out learning and an update of the operation information.

The vehicle-mounted information equipment in accordance with above-mentioned Embodiment 1, can input a manual item identifier via the browsing detecting unit 3 and a plurality of input means which construct the input unit 4, and the browsing detecting unit 3 can create data which is a combination of manual item identifiers acquired by these plurality of input means to send the data to the information-to-be-presented deriving unit 9. In this case, even if all the input means do not acquire manual item identifiers, the browsing detecting unit 3 can create the data and send the data to the information-to-be-presented deriving unit 9 as long as some of the plurality of input means can acquire manual item identifiers.

As the above-mentioned data which is a combination of manual item identifiers acquired by a plurality of input means, for example, there is provided data expressed as a tuple <voice, image, gesture> in which a manual item identifier inputted by voice, a manual item identifier inputted via image capturing, and a manual item identifier inputted via gesture are set up. The information-to-be-presented deriving unit 9 specifies an operation screen from the manual item identifiers described in the received data. In this case, when the same manual item identifier is acquired by a predetermined number or more of input means, the information-to-be-presented deriving unit presumes that the manual item identifier has been inputted by the user A to select the corresponding operation screen.

Because the vehicle-mounted information equipment is constructed in this way, the vehicle-mounted information equipment can eliminate a burdensome process of bringing the manual item identifiers acquired by the plurality of input means into one-to-one correspondence with operation screens to select one of them. Furthermore, the vehicle-mounted information equipment can determine one of the manual item identifiers by using a simple combination of the values acquired by the plurality of input means. In addition, because the vehicle-mounted information equipment uses the plural pieces of information acquired by the plurality of input means, the vehicle-mounted information equipment can also improve the reliability of the determination of an operation screen.

Furthermore, in the vehicle-mounted information equipment in accordance with above-mentioned Embodiment 1, the information-to-be-presented deriving unit 9 can be constructed in such a way as to, when the user has succeeded in performing an operation on the vehicle-mounted information equipment 1 by using the manual 2, hold a history of the display screen displayed on the equipment display unit 10 and resulting from the success of the user's operation in the storage units 5 and 8 and the storing units 6 and 7 as user status information. In this structure, the information-to-be-presented deriving unit can be further constructed in such a way as to determine a priority at the time of searching for display candidates for the user's next or subsequent operation according to the above-mentioned history information. For example, there can be a case in which the information-to-be-presented deriving unit assigns a higher priority to the same candidate as that which is included in the immediately preceding history. In addition, the information-to-be-presented deriving unit can carry out a priority assignment according to a time which has elapsed from a past point in time when the user used the manual 2 or the frequency with which the user has selectively used the manual 2.

Furthermore, although the vehicle-mounted information equipment in accordance with above-mentioned Embodiment 1 determines whether to activate a user input means by using the information stored in the vehicle state information storage unit 5, the device for assisting in using equipment can carry out the process of assisting in using equipment without having to use the vehicle state information and the user status information, depending upon the target equipment to which the device for assisting in using equipment in accordance with the present invention is applied. Therefore, in this case, the storage units 5 and 8 can be eliminated.

### Embodiment 2

A system for assisting in using equipment in accordance with this Embodiment 2 is characterized in that an external server manages a plurality of versions of software or a plurality of versions of a manual. With this structure, the system makes it possible to detect a manual item in the manual which a user is checking to see to enable the user to perform a corresponding operation even in a case in which the version of the manual or equipment is changed.

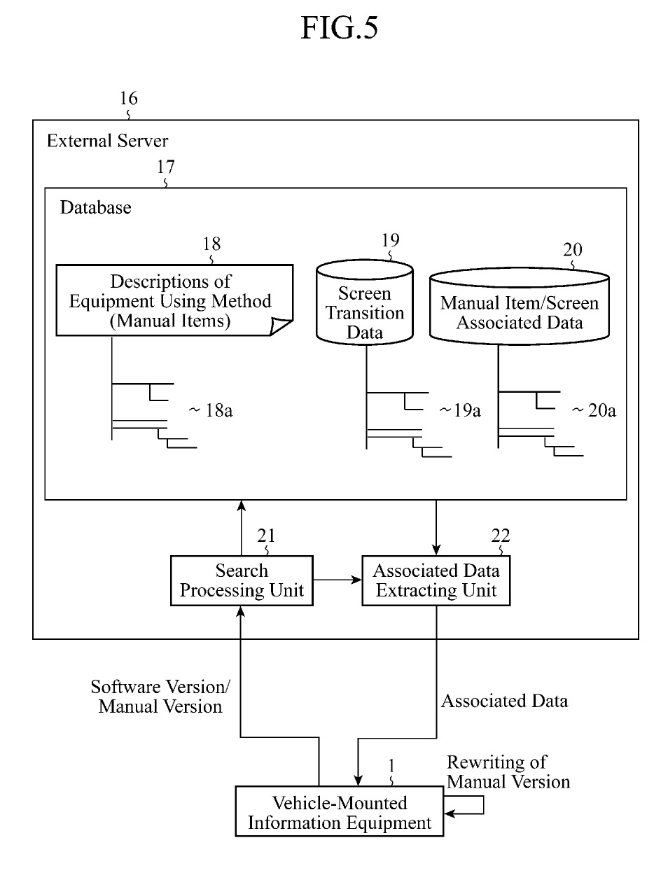

FIG. 5 is a block diagram showing the structure of the system for assisting in using equipment in accordance with Embodiment 2 of the present invention, and mainly shows the structure of the external server that manages information for use in the vehicle-mounted information equipment 1 explained with reference to FIG. 1 in above-mentioned Embodiment 1. In FIG. 5, the external server (a server device) 16 is provided with a database 17, a search processing unit 21, and an associated data extracting unit 22.

In the database 17, the manual 2 and data 18 about this manual, screen transition data and data 19 about this screen transition data, and manual item/screen associated data and data 20 about this manual item/screen associated data, which are used by the vehicle-mounted information equipment 1, are registered. Furthermore, the manual 2 and the data 18 about this manual are registered for each of versions in the database 17. Each of these versions includes a version of the software mounted in the vehicle-mounted information equipment 1, for enabling the user to perform an operation based on the manual 2, and a version of the manual.

In order to identify a manual item of each version of the manual, a numerical value that makes it possible to specify the corresponding version of the software (or that of the manual) (e.g., a numerical value including the version number) needs to be set as a manual item identifier, and, when at least one of the version of the software and that of the manual is updated, the update of the version needs to be detectable. Instead of using a manual item identifier as the version information for specifying the version number, a numerical value which has not been used before the version of the software or manual is updated can be set as the version information.

Furthermore, in the database 17, version tree data 18a having the data 18 about each version as branch information are stored. By using these version tree data 18a, the version information makes it possible to specify the data 18 about the corresponding version. Version tree data 19a and 20a are similarly set for the data 19 and 20 respectively.

The search processing unit 21 is constructed in such a way as to be able to communicate with at least one of a browsing detecting unit 3 and an input unit 4 of the vehicle-mounted information equipment 1. By using the version of the manual 2 acquired from the vehicle-mounted information equipment 1 or the version of the software mounted in the vehicle-mounted information equipment 1 in order to enable the user to perform an operation based on the manual 2, the search processing unit 21 searches through the database 17 for the data 18, 19, and 20 about the corresponding version.

The associated data extracting unit 22 is constructed in such a way as to communicate with at least one of the browsing detecting unit 3 and the input unit 4 of the vehicle-mounted information equipment 1, and extracts the data 18 to 20 which are the search results acquired by the search processing unit 21 from the database 17 and then transmits the data to the vehicle-mounted information equipment 1.

The search processing unit 21 and the associated data extracting unit 22 can be implemented as a concrete means in which hardware and software work in cooperation with each other in a computer by making the computer read a program for assisting in using equipment according to the purposes of the present invention and making the CPU of the computer execute the program to control the operation of the computer.

Next, the operation of the system will be explained.

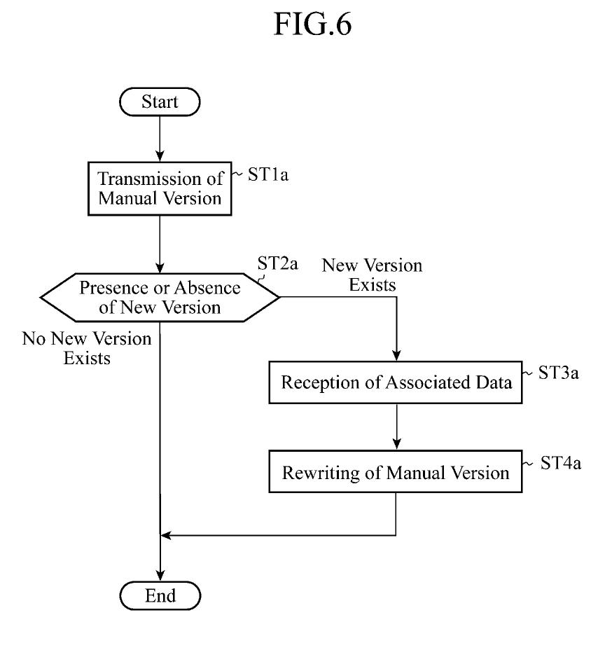

FIG. 6 is a flow chart showing a flow of the operation carried out by the system for assisting in using equipment shown in FIG. 5, and the details of the operation will be explained with reference to this flow chart.

In the vehicle-mounted information equipment 1, when the information-to-be-presented deriving unit 9 determines that a manual item identifier detected by the browsing detecting unit 3 does not exist in the manual, and there is a possibility that the manual or the software for enabling the user to perform an operation based on the manual has been updated first, the information-to-be-presented deriving unit informs the above-mentioned manual item identifier to the external server 16 by using the browsing detecting unit 3 or the input unit 4 (step ST1a). It is assumed that this manual item identifier (which functions as the above-mentioned version information) has a numerical value being able to specify the version of the software (or that of the manual), as mentioned above.

When receiving the above-mentioned manual item identifier (the software version or the manual version) from the vehicle-mounted information equipment 1, the search processing unit 21 of the external server 16 searches through the version tree data 18a, 19a, and 20a of the database 17 by using the version number specified by this manual item identifier so as to determine whether the data 18 to 20 about the corresponding version exist in the database (step ST2a). When the data 18 to 20 about the corresponding version do not exist in the database, the search processing unit 21 ends the processing, whereas when the data 18 to 20 about the corresponding new version exist in the database, the search processing unit 21 informs the data which are the search results to the associated data extracting unit 22.

The associated data extracting unit 22 extracts the data 18 to 20 which are the search results acquired by the search processing unit 21 from the database 17, and transmits the data to the vehicle-mounted information equipment 1. When receiving the data 18 to 20 corresponding to the new version from the external server 16 (step ST3a), the browsing detecting unit 3 or the input unit 4 of the vehicle-mounted information equipment 1 promptly outputs the data to the information-to-be-presented deriving unit 9.

When receiving the data 18 to 20 corresponding to the new version, the information-to-be-presented deriving unit 9 rewrites the data stored in the storing units 6 and 7 and the storage units 5 and 8 by using these data 18 to 20, so that the data corresponding to the new version are stored in the storing units 6 and 7 and the storage units 5 and 8 (step ST4a). As the rewriting process, an update of the version (the version number) of the manual 2 or the software, an addition of a manual item, and a re-setting of manual item identifiers which is caused by an addition of a manual item are carried out.

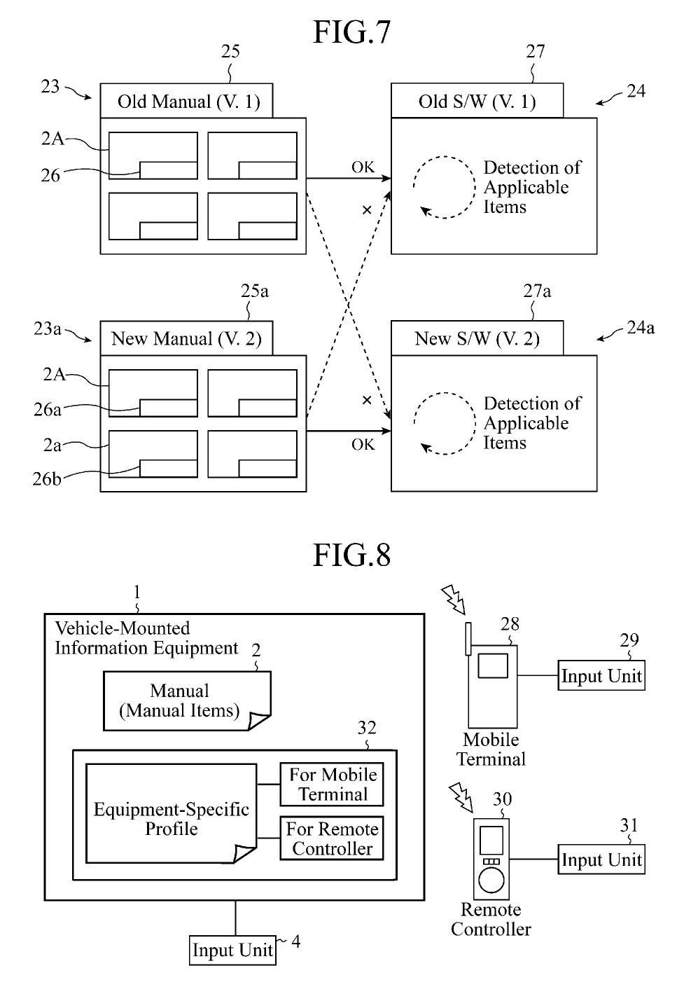

FIG. 7 is a view for explaining the process of rewriting the data corresponding to the new version into the storing units and the storage units. It is assumed that in FIG. 7, when the user performs an operation according to the descriptive content of a manual item 2A in an old manual 23, old software (referred to as old S/W from here on) 24 is executed (this execution is designated by O.K. shown in FIG. 7). It is further assumed that a manual item identifier 26 identifies the manual item 2A, the version 25 of the old manual 23 has a version number 1 (V. 1), and the version 27 of the old S/W 24 has a version number 1 (V. 1).

Hereafter, a case in which a new manual 23a and a new version of vehicle-mounted software (referred to as new S/W from here on) 24a are released will be considered. It is assumed that when the user performs an operation according to the descriptive content of a manual item 2A in the new manual 23a, the new S/W 24a is executed (this execution is also designated by O.K. shown in FIG. 7). It is further assumed that a manual item identifier 26a identifies the updated manual item 2A, the version 25a of the new manual 23a has a version number 2 (V. 2), and the version 27a of the new S/W 24a has a version number 2 (V. 2).

Furthermore, as shown by crosses in FIG. 7, the old manual 23 has no manual item corresponding to an operation newly disposed in the new S/W 24a, while a manual item 2a newly added to the new manual 23a has no operation corresponding to an operation of the old S/W24. Thus, there causes a mismatch between the applicability of the manual items of the old manual and that of the new manual. Therefore, when the new manual 23a and the new S/W 24a are released and used just the way they are, incorrect operation information may be presented to the user.

Because there is no operation corresponding to the manual item identifier 26b for specifying the manual item 2a of the new manual 23a in the old S/W 24, the information-to-be-presented deriving unit 9 can detect that the version has been changed. Similarly, because there is no operation corresponding to the manual item identifier of the old manual 23 in the new S/W 24a, the information-to-be-presented deriving unit 9 can detect that the version has been changed. As a result, the information-to-be-presented deriving unit 9 informs either the version 25a of the new manual 23a or the version 27a of the new S/W 24a to the external server 16 via the browsing detecting unit 3 or the input unit 4.

When receiving the data 18 to 20 corresponding to the new version which are transmitted from the external server 16 in response to the above-mentioned version informed thereto, the information-to-be-presented deriving unit 9 updates the manual item identifiers of the new manual 23a. For example, the information-to-be-presented deriving unit changes the manual item identifier 26 corresponding to the manual item 2A of the old manual 23 to the manual item identifier 26a, and also sets the manual item identifier of the manual item 2a newly added to the new version to the manual item identifier 26b. The information-to-be-presented deriving unit can prevent a mismatch from occurring by reassigning the identifiers to the manual items in such a way that the manual item identifier of the new manual 23a certainly has a larger value than that of the manual item identifier of the old manual 23.

In the above explanation, the case in which a manual exists in the vehicle-mounted information equipment 1, and the version of the manual and that of software are changed to a new version in the vehicle-mounted information equipment 1 is shown. This embodiment is not limited to this example. For example, the system can be constructed in such a way that the vehicle-mounted information equipment 1 downloads or browses a manual 2 disposed in the external server 16 as needed. In this structure, the vehicle-mounted information equipment 1 informs an update of the software and the version of the software to the external server 16, and the external server 16 sends a manual 2 corresponding to the version of the software received from the vehicle-mounted information equipment 1 back to the vehicle-mounted information equipment 1. Because the system is constructed this way, what the vehicle-mounted information equipment 1 has to do is just to make a notification of the new version and an update of the software to the external server.

Furthermore, the associated data transmitted from the associated data extracting unit 22 depend upon the following cases.

(1) A case in which in each of the old and new manuals, a change occurs in only a single manual item while the screen transition data and the manual item/screen associated data do not change.

(2) A case in which in each of the old and new manuals, the correspondence between a manual item and an item changes.

In the above-mentioned case (1), the whole or a part of a single manual item is extracted as associated data, and when changing the part of the single manual item, the associated data extracting unit 22 creates a tuple <source data position in single item, changed size, changed data, changed version> on the basis of the information extracted from the database 17, and transmits the tuple to the vehicle-mounted information equipment 1. In this case, the external server 16 holds a tuple <version before change, source data position in single item, changed size, changed data, changed version> in each of the data 18 to 20 of the database 17 to manage each of the data.

In the above-mentioned case (2), because a wide range change is required, the associated data extracting unit 22 transmits, as the associated data, the manual items, the screen transition data, and difference data about the manual item/screen associated data. In this case, the external server 16 holds <original version, difference data, new version> corresponding to each of the data 18 to 20 in the database 17 to manage each of the data. An existing format (e.g., a diff format) can be used as the format of the difference data.

Furthermore, as a method of updating the software for use in the vehicle-mounted information equipment 1, a method of updating the software using a recording medium, such as a normal CD or a method of updating the software using a network can be used. In addition, the system can be constructed in such a way as to update the manual at the same time when updating the software via the network.

As mentioned above, because the system for assisting in using equipment in accordance with this Embodiment 2 includes the above-mentioned external server 16 and the above-mentioned vehicle-mounted information equipment 1, the system can prevent a screen transition between screens which must be unable to occur from taking place due to a difference between the version of the manual and that of the software or the like, and can also present the new correct manual to the user.

### Embodiment 3

In a system for assisting in using equipment in accordance with this Embodiment 3, a manual is disposed in vehicle-mounted information equipment, and a manual item and an equipment operation screen are presented to external equipment having a communications function (a mobile phone, a handheld game machine, a remote controller equipped with a liquid crystal display, or the like) and a user is enabled to operate the vehicle-mounted information equipment 1 via the external equipment.

FIG. 8 is a view schematically showing the structure of the system for assisting in using equipment in accordance with Embodiment 3 of the present invention. In FIG. 8, a mobile terminal (one external equipment) 28 can communicate with the vehicle-mounted information equipment 1, and enables the user to operate the vehicle-mounted information equipment 1 by using an input unit 29 according to a manual item and an equipment operation screen which are presented to the user by the vehicle-mounted information equipment 1. This mobile terminal 28 can be implemented by, for example, a mobile phone or a handheld game machine.

A remote controller (one external equipment) 30 can communicate with the vehicle-mounted information equipment 1, and enables the user to operate the vehicle-mounted information equipment 1 by using an input unit 31 according to a manual item and an equipment operation screen which are presented to the user by the vehicle-mounted information equipment 1. As the remote controller 30, a normal remote controller equipped with a liquid crystal display can be used.

An equipment profile 32 includes a profile of each external equipment which can work in cooperation with the vehicle-mounted information equipment 1 and which is registered into storing units 6 and 7 and storage units 5 and 8 of the vehicle-mounted information equipment 1. As this profile 32, the equipment ID for each external equipment, UI data available in each external equipment (information about operation screens which can be displayed on the display unit of each external equipment and information about input units) etc. are registered.

Next, the operation of the system for assisting in using equipment will be explained.

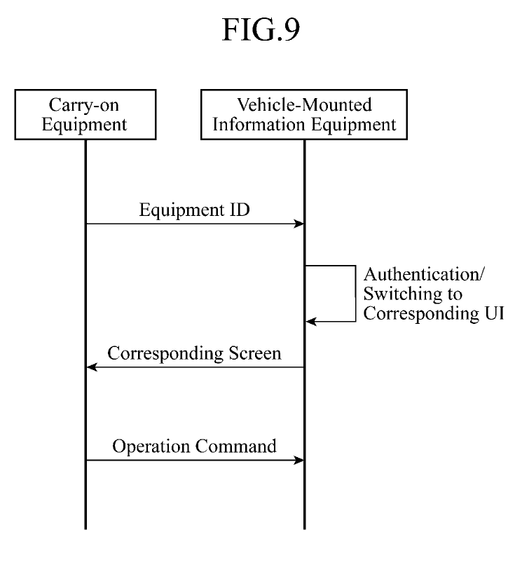

FIG. 9 is a timing chart showing an equipment operation carried out by the system for assisting in using equipment shown in FIG. 8, and the details of the operation will be explained with reference to this timing chart.

When the mobile terminal 28 shown in FIG. 8 is used as carry-on equipment, the mobile terminal 28 transmits the equipment ID specific to the mobile terminal itself to the vehicle-mounted information equipment 1 first. When receiving the above-mentioned equipment ID via a browsing detecting unit 3 or the like, an information-to-be-presented deriving unit 9 of the vehicle-mounted information equipment 1 searches for the corresponding equipment profile 32 by using this equipment ID and then authenticates the corresponding external equipment.

After authenticating that the mobile terminal 28 is the external equipment corresponding to the equipment ID received thereby, the information-to-be-presented deriving unit 9 switches to a UI (User Interface) corresponding to the mobile terminal 28 according to the equipment profile 32. More specifically, the information-to-be-presented deriving unit switches to an operation mode in which the information-to-be-presented deriving unit accepts information about an operation performed on the mobile terminal 28 and carries out a process as shown in above-mentioned Embodiment 1 according to the information about the operation performed on the mobile terminal 28 (i.e., an operation program corresponding to the operation performed on the mobile terminal 28).

The information-to-be-presented deriving unit 9 then transmits corresponding screen information to the mobile terminal 28. This corresponding screen information specifies a manual screen formed in a file format which can be displayed by, for example, the mobile terminal 28. At this time, the vehicle-mounted information equipment 1 activates an input from the input unit 29 of the mobile terminal 28.

After that, when the user inputs the manual item identifier of a manual item which he or she desires to operate in the manual displayed on the screen of the mobile terminal 28 by using the input unit 29, the mobile terminal 28 informs the manual item identifier to the vehicle-mounted information equipment 1 and the vehicle-mounted information equipment 1 carries out the same process as that shown in above-mentioned Embodiment 1.

When the operation screen of the manual item which the user desires to operate is displayed on the mobile terminal 28 in the above-mentioned way, and the user makes an operational input by using the input unit 29, a corresponding operating command is transmitted to the vehicle-mounted information equipment 1 side and the operation is carried out. Also when the user uses the remote controller 30, the system enables the user to operate the vehicle-mounted information equipment 1 by carrying out the same process as that mentioned above.

As mentioned above, because the system for assisting in using equipment in accordance with this Embodiment 3 includes the above-mentioned vehicle-mounted information equipment 1, the above-mentioned mobile terminal 28 and the above-mentioned remote controller 30, the system enables the user to operate the vehicle-mounted information equipment 1 by using an input method and a presentation method according to the characteristic features of the carry-on equipment, such as the mobile terminal 28 or the remote controller 30.

### INDUSTRIAL APPLICABILITY

Because the device for assisting in using equipment and the system for assisting in using equipment in accordance with the present invention enable the user to perform a desired operation on the target equipment certainly through a simple operation, and can carry out learning and an update of the operation information, the device for assisting in using equipment and the system for assisting in using equipment are suitable for use as a device for assisting in using equipment that assists the use of vehicle-mounted information equipment or the like, and a system for assisting in using equipment or the like using the device for assisting in using equipment respectively.

1. A device for assisting in using equipment that assists in operating target equipment according to an operation manual, said device comprising:
an identifier acquiring unit for acquiring an operation item identifier identifying an operation item described in said operation manual;
a first storing unit for storing screen transition data showing a correspondence between data showing whether a screen transition among operation screens is enabled or disabled, and screen identifiers each identifying one of said operation screens;
a second storing unit for storing associated data showing a correspondence between said operation item identifier and a screen identifier identifying an operation screen for enabling an operation based on the operation item specified by said operation item identifier to be performed; and
an information-to-be-presented deriving unit for deriving an operation screen corresponding to the operation item identifier acquired by said identifier acquiring unit on a basis of the screen transition data stored in said first storing unit and the associated data stored in said second storing unit to display said operation screen on said target equipment.

2. The device for assisting in using equipment according to claim 1, wherein said device includes a third storing unit for storing moving object status information showing a status of a moving object in which the target equipment is mounted, and the information-to-be-presented deriving unit limits the acquisition of the operation item identifier by the identifier acquiring unit according to the status of said moving object specified by said moving object status information and also derives an operation screen which is determined to be able to be displayed according to the status of said moving object.

3. The device for assisting in using equipment according to claim 1, wherein said device includes a fourth storing unit for storing information about an operator who operates the target equipment, and the information-to-be-presented deriving unit has a setting showing whether each of the operation screens can be displayed according to the information about said operator, and derives an operation screen which is set to be able to be displayed according to the information about said operator.

4. The device for assisting in using equipment according to claim 3, wherein the fourth storing unit stores information about a history of the operator's operations, and the information-to-be-presented deriving unit assigns a display priority on the target equipment to each derived candidate for the operation screen according to the information about said history of the operator's operations.

5. The device for assisting in using equipment according to claim 3, wherein the fourth storing unit stores ID information identifying the operator, and the information-to-be-presented deriving unit performs a process of authenticating the operator according to said ID information.

6. The device for assisting in using equipment according to claim 1, wherein said device includes a plurality of identifier acquiring units, and, according to information which is a combination of operation item identifiers acquired by said plurality of identifier acquiring units, the information-to-be-presented deriving unit derives operation screens corresponding to said operation item identifiers.

7. A system for assisting in using equipment that assists in operating target equipment according to an operation manual, said system comprising:
a server device including a database for storing both screen transition data showing a correspondence between data showing whether a screen transition among operation screens is enabled or disabled, and screen identifiers each identifying one of said operation screens, and associated data showing a correspondence between said operation item identifier and a screen identifier identifying an operation screen for enabling an operation based on the operation item specified by said operation item identifier to be performed for each version information about said operation manual and for each version information about software mounted in said target equipment in order to enable an operation described in said operation manual to be performed, a search processing unit for searching through said database for corresponding data according to version information received thereby, and an associated data extracting unit for extracting data corresponding to the search result acquired by said search processing unit from said database; and
a device for assisting in using equipment including an identifier acquiring unit for acquiring the operation item identifier identifying the operation item described in said operation manual, a first storing unit for storing the screen transition data showing a correspondence between data showing whether a screen transition among operation screens is enabled or disabled, and screen identifiers each identifying one of said operation screens, a second storing unit for storing the associated data showing a correspondence between said operation item identifier and a screen identifier identifying an operation screen for enabling an operation based on the operation item specified by said operation item identifier to be performed, and an information-to-be-presented deriving unit for detecting if there is a change in said version information according to presence or absence of the operation screen corresponding to the operation item identifier acquired by said identifier acquiring unit to transmit the changed version information to said server device, and also updating the screen transition data stored in said first storing unit and the associated data stored in said second storing unit by using received data corresponding to said changed version information and transmitted from said server device in response to said changed version information, and for deriving an operation screen corresponding to said operation item identifier on a basis of the updated screen transition data and the updated associated data to display said operation screen on said target equipment.

8. The system for assisting in using equipment according to claim 7, wherein the associated data extracting unit extracts the corresponding data from the database according to the changed version information received from the device for assisting in using equipment, and also detects a description of an operation item which has been changed with the change in the version information and transmits data corresponding to only a change in the description to said device for assisting in using equipment, and the information-to-be-presented deriving unit updates the screen transition data stored in the first storing unit and the associated data stored in the second storing unit by using the data corresponding to only the change in the description.

9. A system for assisting in using equipment that assists in operating target equipment according to an operation manual, said system comprising:
a server device including a database for storing both screen transition data showing a correspondence between data showing whether a screen transition among operation screens is enabled or disabled, and screen identifiers each identifying one of said operation screens, and associated data showing a correspondence between said operation item identifier and a screen identifier identifying an operation screen for enabling an operation based on the operation item specified by said operation item identifier to be performed for each version information about said operation manual and for each version information about software mounted in said target equipment in order to enable an operation described in said operation manual to be performed, a search processing unit for searching through said database for corresponding data according to version information received thereby, and an associated data extracting unit for extracting data corresponding to the search result acquired by said search processing unit from said database; and
a device for assisting in using equipment including an identifier acquiring unit for acquiring the operation item identifier identifying the operation item described in said operation manual, and an information-to-be-presented deriving unit for, when a version of the software mounted in said target equipment in order to enable an operation described in said operation manual to be performed is updated, transmitting updated version information showing the updated version to said server device, also deriving an operation screen corresponding to said operation item identifier according to said screen transition data and said associated data which are transmitted from said server device in response to said updated version information, and which correspond to said updated version information to display said operation screen on said target equipment.

10. A system for assisting in using equipment that assists in operating target equipment according to an operation manual, said system comprising:
external equipment for enabling an operation to be performed on said target equipment according to an operation screen based on said operation manual; and
a device for assisting in using equipment including an identifier acquiring unit for acquiring an equipment profile in which information identifying said external equipment is stored, and an operation item identifier identifying an operation item described in said operation manual from the external equipment specified by said equipment profile, a first storing unit for storing screen transition data showing a correspondence between data showing whether a screen transition among said operation screens is enabled or disabled, and screen identifiers each identifying one of said operation screens, a second storing unit for storing associated data showing a correspondence between said operation item identifier and a screen identifier identifying an operation screen for enabling an operation based on the operation item specified by said operation item identifier to be performed, and an information-to-be-presented deriving unit for deriving an operation screen corresponding to the operation item identifier acquired by said identifier acquiring unit on a basis of the screen transition data stored in said first storing unit and the associated data stored in said second storing unit to display said operation screen on said external equipment specified by said equipment profile.
